(19) United States
(12) Patent Application Publication
(10) Pub. No.: US 2002/0082907 A1
(43) Pub. Date: Jun. 27, 2002

(54) Method for conducting a shareholders meeting with remote participation using a network

(75) Inventors: Hirofumi Inomata, Tokyo (JP); Hideo Noyama, Tokyo (JP); Takeshi Matsuki, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 09/990,951

(22) Filed: Nov. 16, 2001

(30) Foreign Application Priority Data
Dec. 25, 2000 (JP) 2000-396910

(51) Int. Cl. G06F 17/60

(52) U.S. Cl. 705/12

(57) ABSTRACT

The present invention provides a method for conducting a shareholders meeting when shareholders can participate in the shareholders meeting through a network without having to actually go to the meeting hall of the shareholders meeting. Remote shareholders are assigned to satellite sites in order to spread the processing load among the satellite sites. Among the meeting site, satellite sites, and remote shareholder sites of the sponsoring company, votes from remote shareholders sites are tabulated on the satellite sites and sent to the meeting site. Voting can be performed promptly because of hierarchical vote tabulation on a plurality of satellite sites and at the meeting site.

### CROSS-REFERENCES TO RELATED APPLICATIONS

This application is related to and claims priority from Japanese Patent Application No. 2000-396910, filed on Dec. 25, 2000.

### BACKGROUND OF THE INVENTION

The present invention relates to a system for conducting a shareholders meeting.

Companies which issue stock hold shareholders meetings at least once a year. The meetings are held at a location near company headquarters and the account settlement statement is approved and directors are elected. To notify shareholders of the meeting, a transfer agent is commissioned by the sponsoring company to mail out the notice to each shareholder. Shareholders respond to the notices by mailing back notice of their attendance or absence. The agenda and measures are already noted in the notice. When a shareholder is not attending the shareholders meeting (not going to the meeting hall on that date), the shareholder indicates his or her assent or objection to each agenda item and measure on a voting form or proxy and returns this by mail. When the notice is returned to the company, the company considers the numbers of shares held by those shareholder according to those voting forms and tabulates the votes to assent and object to the measures.

Tabulation of the votes should be carried out cautiously so there are no errors. However, there is little room in the schedule between when the notices are mailed out and returned until the date of the meeting. Even though caution is expected, it takes time to use methods for double checking by hand and it is not possible to tabulate the votes. Also, on the date of the meeting, it is necessary to tabulate votes as well as confirm the attendance of shareholders who come to the meeting hall. Accordingly, the following types of prior art exist as systems relating to the conducting of shareholders meetings, and particularly to the tabulation of votes.

Prior art 1: Japanese Patent Application Laid-open No. H06-187518.

This is a system wherein an alphanumeric code or bar code indicating the shareholder number, number of shares, and so forth is printed in advance on the guide for the shareholders meeting, specifically the voting form, and the voting forms recovered before the meeting and voting forms recovered from persons attending the shareholders meeting on the date of the meeting are tabulated by reading those alphanumeric codes and bar codes.

Prior art 2: Japanese Patent Application Laid-open No. H11-184946.

This is a bar code reading apparatus relating to tabulating votes wherein the value of one vote varies according to the shareholder, for voting by exercising voting rights such as at a shareholders meeting according to the commercial code, wherein a bar code showing the individual number of a voter, or a bar code relating to the amount of voting rights is printed in advance on the ballot, and the results of the vote are tabulated by reading the contents of the ballot.

Prior art 3: Japanese Patent Application Laid-open No. 2000-278263.

This is a system relating to a conference support system with which all participants (shareholders) at a shareholders meeting can see the conference data on individual terminal devices, and wherein matters are resolved by the results of weighting and tabulating data for each decision from each vote input from each terminal device.

The prior art discussed above comprises (1) tabulating by hand the indication of assent or objection to with measures and the number of shares being voted for that indication, with voting forms mailed to the company from non-attending shareholders before the shareholders meeting; and (2) recovering the voting forms at the time of the meeting from shareholders attending the shareholders meeting, and tabulating the shareholder attendance and the numbers of shares voted.

However, the prior art does not systematize the tabulation of the numbers of shares voted and the persons attending the meeting. The tabulation is carried out by the company. In effect, tabulation in the prior art is performed by one central facility regardless of whether the tabulation is performed in advance or on the date of the meeting. The central facility necessarily becomes a large scale facility because a large amount of shareholder information is processed all at once therein. However, since shareholders meetings are only once a year, the large scale facility is not practical because of its cost.

Moreover, remote shareholders need to be able to participate in real time in the proceedings at the shareholders meeting, but there are no methods for carrying out proceedings without falling behind because of effects from mass access.

Voting at the shareholders meeting is a very important matter for the company and fraudulent intervention in this voting must not be permitted, even when a network is used for the shareholders meeting system.

What is needed is a system and method for conducting a shareholders meeting with remote participation (hereinafter “electronic shareholders meeting”) allowing the participation of remote shareholders in the shareholders meeting. It is desirable to provide a system and method for conducting a shareholders meeting which includes remote shareholders. There is a need to provide a system and method for conducting a shareholders meeting and ensuring the same access opportunities for remote shareholders as for the shareholders in attendance at the meeting.

### SUMMARY OF THE INVENTION

A method for providing remote participation of a shareholders meeting includes assigning satellite server sites to remotely attending shareholders, thus providing them with remote access to the meeting. Each satellite site tabulates votes for its assigned remote shareholders and forwards a tabulated votes result to a server of the sponsoring company. The tabulated votes result represents the voting preferences of the remote shareholders assigned to the satellite site. The satellite site allows for re-casting of votes, where an earlier submitted voting form of a remote shareholder is deleted in favor of a most recently submitted voting form.

The use of satellite sites spreads the processing load among such sites thus making possible large numbers of remotely attending shareholders to participate in the shareholders meetings. The use of satellite sites obviates the need for the sponsoring company to provide maintain such servers for shareholders meetings, which are quite infrequent.

### BRIEF DESCRIPTION OF THE DRAWINGS

FIG. 1 is a drawing showing a schematic of the constitution of the present invention;

FIG. 2 is a drawing to explain processing for notifying shareholders of the electronic shareholders meeting;

FIG. 3 is a drawing to explain processing for shareholder verification, vote tabulation, meeting broadcast, and questioning during the meeting;

FIG. 4 is a drawing showing processing to realize discussion among shareholders during the meeting;

FIG. 5 shows the constitution of the company server 11;

FIG. 6 shows the constitution of the transfer agent company server 12;

FIG. 7 is a drawing showing the constitution of the satellite site 14;

FIG. 8 is a drawing showing an example of the notice of the meeting;

FIG. 9 is a drawing to explain processing for generating the shareholders meeting participation ID;

FIG. 10 is a drawing to explain processing to generate the notice for the meeting;

FIG. 11 to drawing to explain the shareholder client reception processing screen;

FIG. 12 is a drawing to explain the shareholder client reception processing screen and verification screen;

FIG. 13 is a drawing to explain decryption processing;

FIG. 14 is a drawing to explain the voting operation; and

FIG. 15 is a drawing to explain the voting operation.

### DESCRIPTION OF THE SPECIFIC INVENTION

Further practical issues and means for resolving those are discussed below in a brief introduction to aspects of the specific illustrative embodiments of the invention.

In order to conduct a shareholders meeting with remote participation (electronic shareholders meeting) to achieve the abovementioned objectives, the present invention includes satellite sites established between the sponsoring company and the remote shareholders. The verification of remote shareholders and the tabulation of votes are carried out in the satellite sites. In this way, the central facilities for the sponsoring company and satellite sites are improved just by carrying out batch processing. In other words, it becomes possible to conduct the shareholders meeting with a smaller facility, as compared with a facility for performing on-line processing.

When guides for the shareholders meeting are mailed out to remote shareholders, the shareholders are notified of information such as access points close to the shareholders' homes, as well as the shareholder ID and password.

When the shareholders meeting is held, encrypted information (including the shareholder ID and the number of shares held) is sent to the satellite sites.

When a remote shareholder accesses the satellite site, the program on the satellite site applies a password to the encrypted information and attains an output value.

Next the output value is decrypted with the public key of the sponsoring company. The result is a decrypted output value; if the correct shareholder ID is included in the decrypted output value, the shareholder is verified to be the correct shareholder.

When a vote is held, information regarding the number of shares held included in the decrypted output value, the shareholder ID, password, and the approval code are tabulated and sent to the central facilities of the sponsoring company.

The abovementioned satellite site sends question information for the shareholders meeting received from the abovementioned shareholder clients to the abovementioned central facility for a period of time designated by the abovementioned central facility. When the abovementioned designated period of time has passed, question information, excluding questions selected by the abovementioned central facility, is deleted.

The present invention is explained below with reference to the drawings.

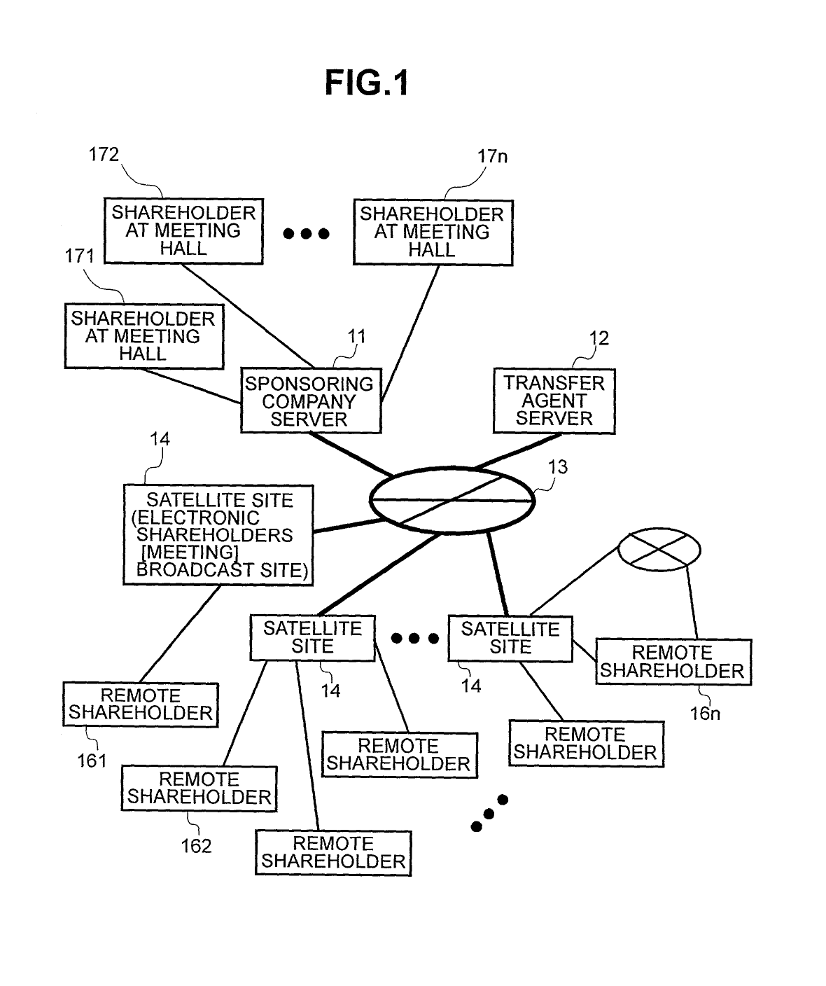

FIG. 1 shows the relationships among the sites constituting the present invention. Networks 13 and 15 connect the server 11 of the company holding the shareholders meeting (sponsoring company), the server 12 of the transfer agent company, the communications terminals (shareholders meeting clients 161, 162, , 16n) of the shareholders owning stock issued by the sponsoring company, and the satellite sites 14 controlling the transfer of information for the shareholders meeting held by the company between the sponsoring company or transfer agent company and the shareholders. The network 13 linking the sponsoring company server 11, the transfer agent company 12, and satellite sites 14 uses VPN (a network security protocol from Netscape), for example, for safe data exchange. The network 15 between the satellite sites 14 and the shareholders meeting clients 16n may use an SSL wide area network, or may have direct communications links through telephone subscriber lines.

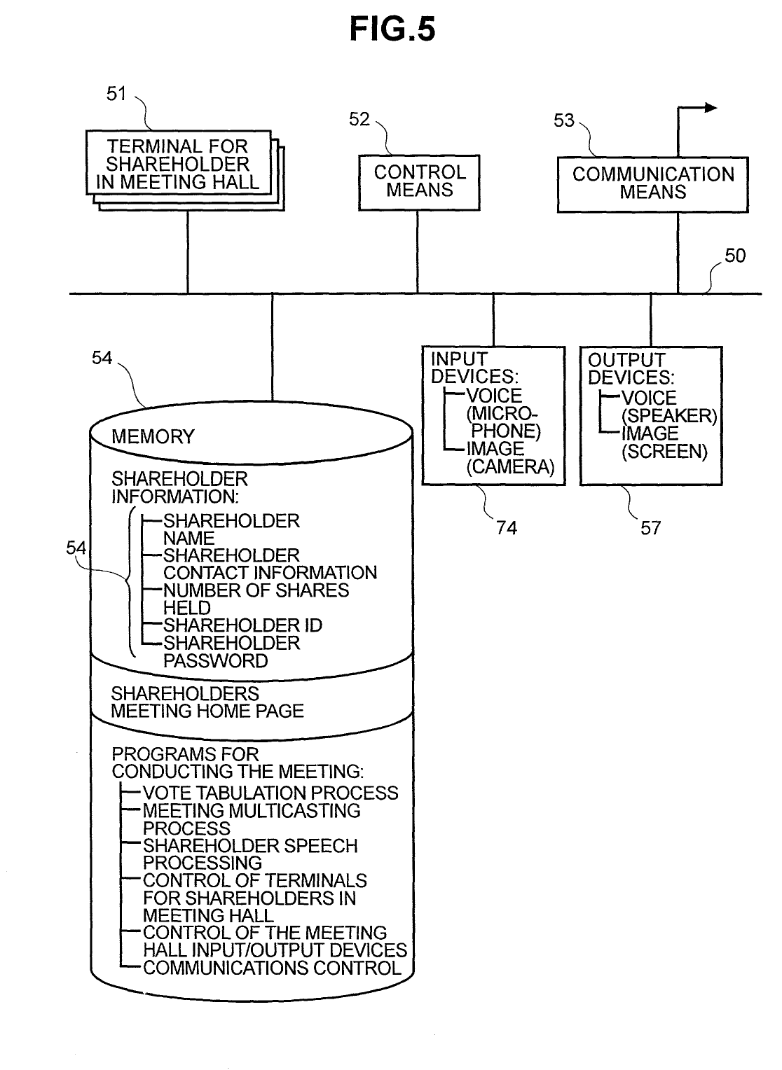

FIG. 5 shows a typical constitution of the sponsoring company server 11. The sponsoring company server 11 is connected with a plurality of local shareholder terminals 51, control means 52, communications means 53, memory 54, input devices 56, and output devices 57 through a system bus 50.

The present invention allows remote shareholders to participate in the shareholders meeting, and also provides local shareholder terminals for shareholders participating at the meeting hall because shareholders are actually present at the meeting hall as before now. Moreover, the constitution of the local shareholder terminals 51 uses information processing devices provided with input/output devices. Speakers, earphones, cameras, and microphones may also be provided. Providing terminals to shareholders present at the meeting hall has the following advantages. Methods for taking a vote at the meeting hall include methods relying on the senses, such as a show of hands, applause, should probably be “voice”, and standing. With a show of hands, there is a possibility that even big shareholders will only have the same weight as a shareholder with a single vote. When voting rights are exercised through terminal input, the votes of present and remote shareholders will be treated equally and quantitative results without room for dispute can be attained.

The communications means 53 are an interface for transferring information outside the system. In addition to the communication of information between the transfer agent company server 12 and satellite sites 14, the communications means 53 also carry out the communication of information, from the shareholders meeting clients 16n through a regular Internet service provider, such as receiving requests to access the shareholders meeting home page created by the sponsoring company and sending the home page.

Shareholder information, the shareholders meeting home page, and programs for conducting the shareholders meeting are stored in the memory 54. The shareholder information 55 includes the shareholder name, shareholder ID, shareholder contact information, the number of shares held, and a password determined by the shareholder at the time shareholder purchased the shares. Sometimes the electronic signature of the shareholder is registered as well.

The programs for conducting the meeting include programs for carrying out vote tabulation processing, meeting multicast processing, shareholder speech processing, local shareholder terminal control, local input/output device control, and communications control. Information and programs stored in the memory 54 are read to the control means 52, the data are referenced, and processing programs are executed. In the present embodiment, when processing programs and data stored in the memory 54 other than those discussed above are executed or referenced, an explanation will be provided at that time.

The input devices 56 include an input device used for controlling the entire sponsoring company server 11, an input device whereby the chairman controls the progress of the meeting during the meeting, and an input device for images and sounds necessary for multicasting the meeting. Specifically, keyboards, mice, pointing devices, pads, microphones, and cameras can be used as the input devices. The output devices 57 include an output device used for controlling the entire sponsoring company server 11 and output devices used for conducting the meeting. For example, these include shared screens established at the meeting hall and speakers for outputting voices to the meeting hall.

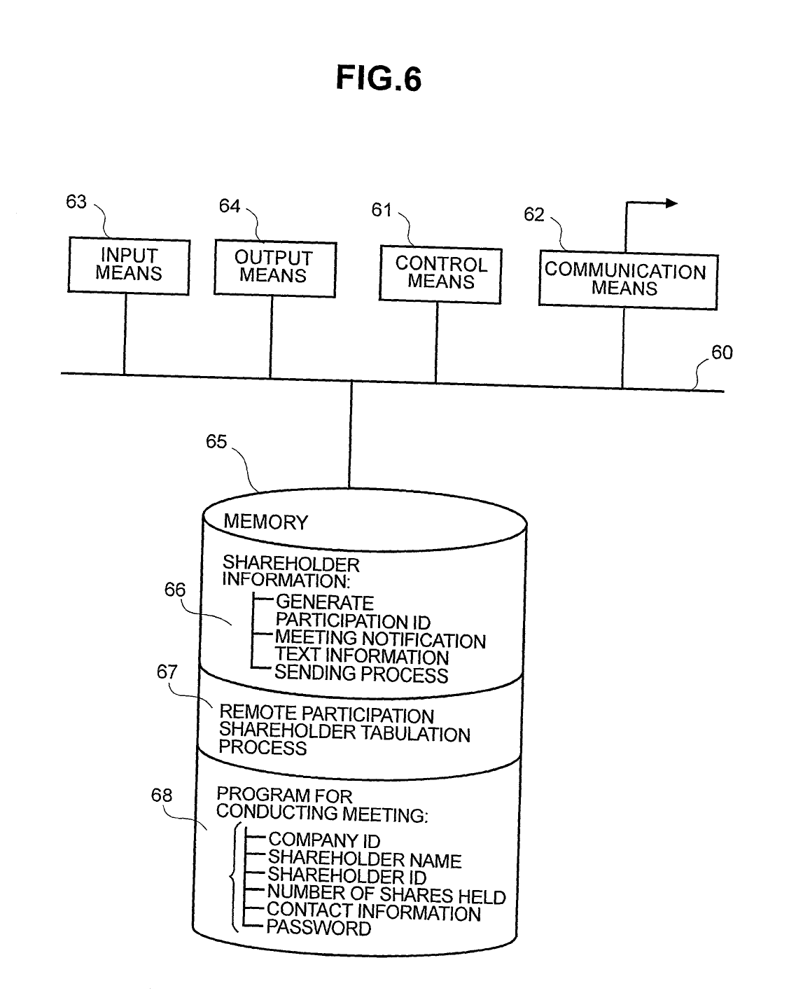

FIG. 6 shows the constitution of the transfer agent company server 12. The transfer agent company server 12 comprises means for communicating outside the system 62, output means 64 such as a display or printer, input means 63 such as a keyboard, mouse, or pointing device, memory 65 for storing programs and information, control means 61 for controlling system operations, and a system bus 60 for connecting these elements. The following are stored in the memory 65: shareholder information 68, shareholders meeting notice generating programs 66 for generating and sending notice of the shareholders meeting to shareholders indicated in the shareholder information 68, a program for generating the shareholder participation ID necessary for generating the notice, the text information of the notice, and a transfer processing program for sending the notice generated to the shareholders.

Shareholders participating in the shareholders meeting in the notice from a remote location through a network can notify the sponsoring company or transfer agent company in advance of their attendance. When the transfer agent company performs the reception and tabulation of notices from persons planning to participate in the electronic shareholders meeting, a program 67 for tabulating remote participation shareholders is provided in the memory 65. When the reception and tabulation of notices from persons planning to participate in the electronic shareholders meeting is carried out on the sponsoring company server 11, a program like the program 67 for tabulating remote participation shareholders may be provided in the memory 54 of the sponsoring company server 11.

Further, the sponsoring side learns of the sites which have capability to provide the services of a satellite site. Since some remote participants may not have access to a satellite site, the sponsoring side can assign such participants to one of the known satellite sites, for example by emailing the URL (universal resource locator) of the one of the known satellite sites.

Also, when the ISP (Internet service provider) to be accessed by the remote shareholders does not have an electronic shareholders meeting broadcast system, the sponsoring company can have software installed at the ISP to provide services as a satellite site in advance of the meeting so that the electronic shareholders meeting broadcast can be performed, or can recommend satellite sites including the electronic shareholders meeting broadcast system so that remote shareholders can surely participate in the meeting, and can conduct the electronic shareholders meeting smoothly.

The shareholder information 68 includes the company ID of the company for which the transfer agent company acts, the shareholder name of the shareholder owning stock in that company, shareholder ID, number of shares held, shareholder contact information, and passwords. The shareholder contact information includes the postal address, and may also include the e-mail address. The priority ranking of the postal address and e-mail address may be indicated with a flag of 1 or 0 and communications relating to the stocks may be made using postal mail or e-mail according to that priority ranking. The password included in the shareholder information 68 is an arbitrary string of alphanumeric characters determined by the shareholder at the time the shares are purchased.

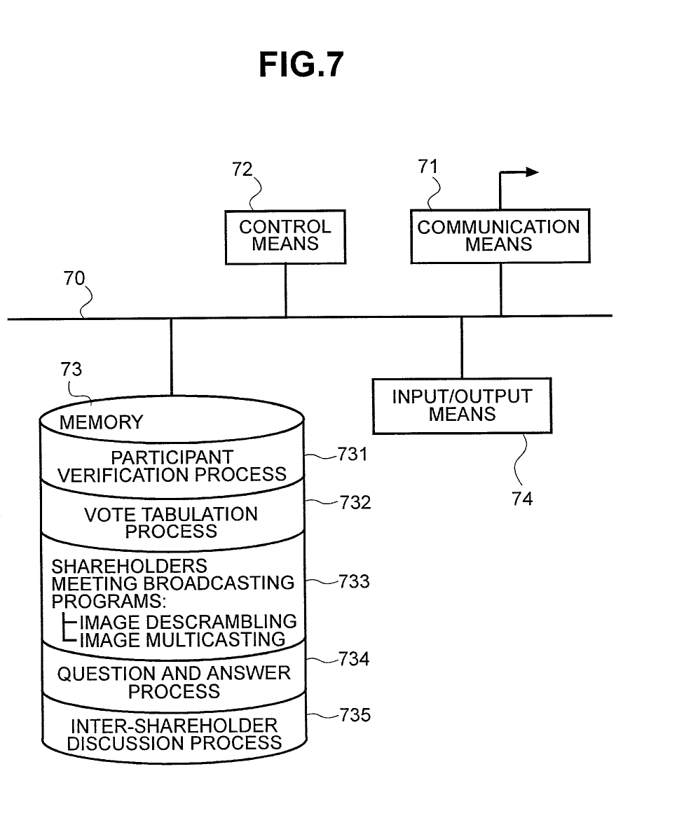

Next, FIG. 7 shows the constitution of the satellite sites 14. A satellite site 14 includes communications means 71 for communicating outside the system with the shareholders meeting clients 16n or the sponsoring company server 11, memory 73 storing various processing programs functioning as the electronic shareholders meeting broadcast system, control means 72 for executing the processing programs in the memory 73, and input/output means 74 necessary for system operations. Though not explained here, the control means 72 also control communications processes and routing processes for normal ISP processing.

The memory 73 is provided with program code which collectively constitute shareholders meeting services. Such programs include, but are not limited to, a participant verification processing program 731, a vote collection processing program 732, a shareholders meeting relay and multicast program 733, a question and answer processing program 734, an inter-shareholder discussion processing program 735, and a working memory area, not shown. When processing programs and data not shown in the memory 73 are executed or referenced, an explanation will be provided at that time.

The shareholders meeting clients 16n used by remote shareholders to attend the electronic shareholders meeting may be regular personal computers. In some cases, it will be necessary to acquire a special plug-in for the electronic shareholders meeting in advance of the shareholders meeting in order to provide the above-referenced shareholders meeting services.

The processing among the sites is explained.

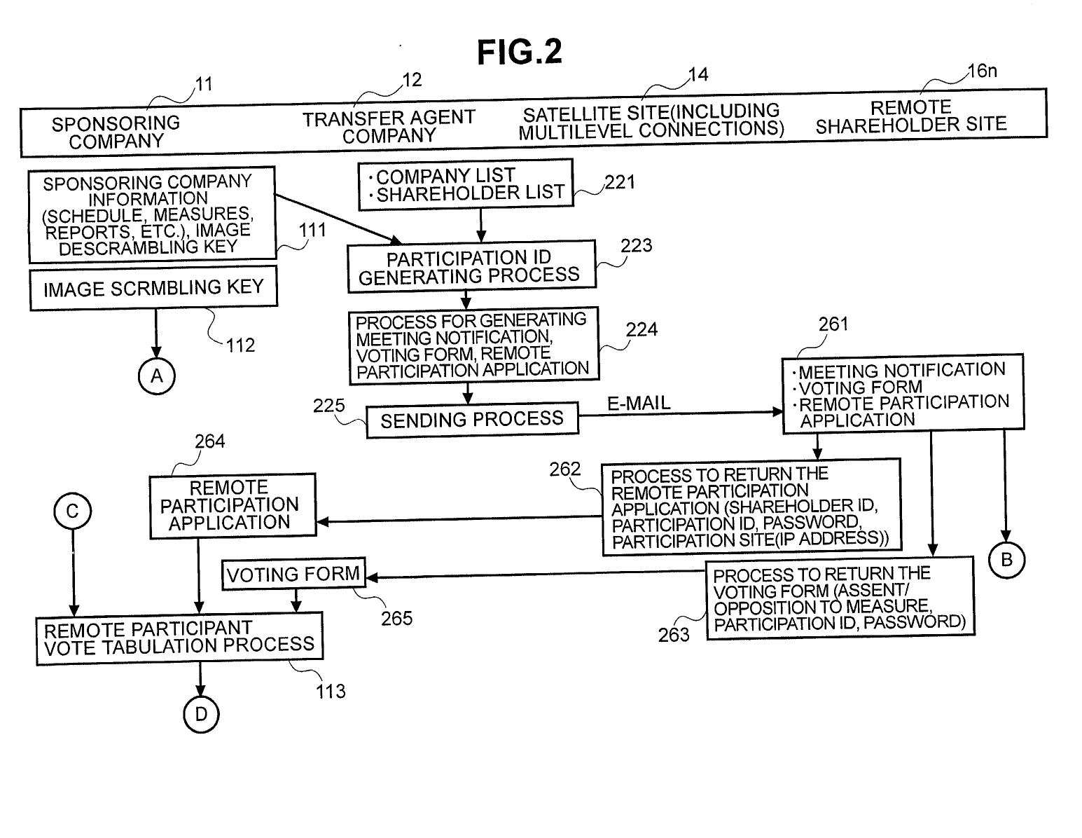

The processing for notifying the shareholder of the electronic shareholders meeting is explained using FIG. 2. This processing corresponds to the explanation for the operation of the shareholders meeting notice program stored in the memory 65 of the transfer agent company server 12. After the sponsoring company determines a closing date, the transfer agent company is notified of resolutions and reports for the shareholders meeting, and the reference date which defines the list of shareholders (111) for the shareholders meeting. The shareholders meeting notice generating program 66 is started on the transfer agent company server 12. The participation ID generating process (223) is executed.

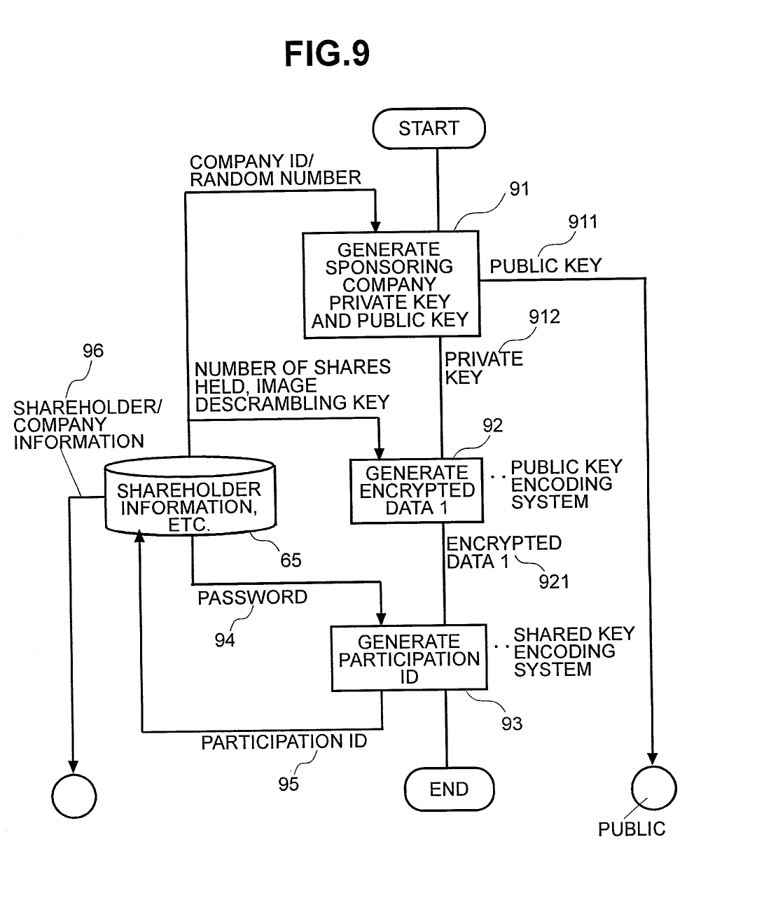

FIG. 9 shows the participation ID generating process (223). Once the processing begins, the company ID of the sponsoring company that requested the notification is read from the memory 65, paired with a random number, and a public key and private key for this company is generated from the random number (91). The public key 911 is published to the satellite sites 14 and the sponsoring company 11. Next, the image descrambling key for viewing the live meeting and the numbers of shares belonging to shareholders for whom participant IDs were generated are read from the memory 65 and encrypted data 1 are generated with the public key encryption system using the private key 912 (92). At this time, shareholders are those shareholders registered to the shareholder list on the reference date which defines the list of shareholders. Next, with the shared key encryption system, participation IDs (95) are generated from the encrypted data 1 (921) and the individual shareholder passwords 94 read from the memory 65 (93). The password can be the multi-digit sequence of numbers determined by individual shareholders at the time shares are purchased, or the unique password generated for a shareholder by turning the shareholder ID into a string of digits with a hash function. In that case, a shareholder ID is run through the hash function again in order to decode the cipher afterwards. Moreover, in Step 92, either the shareholder data or company data stored in the memory 65 may also be encrypted.

After the participation ID generating process (223) is completed, processes for generating notices, voting forms, and remote participation applications (224, hereinafter “processes for generating notices and so forth”) are executed next. Programs and data for carrying out these processes are stored in the memory 65.

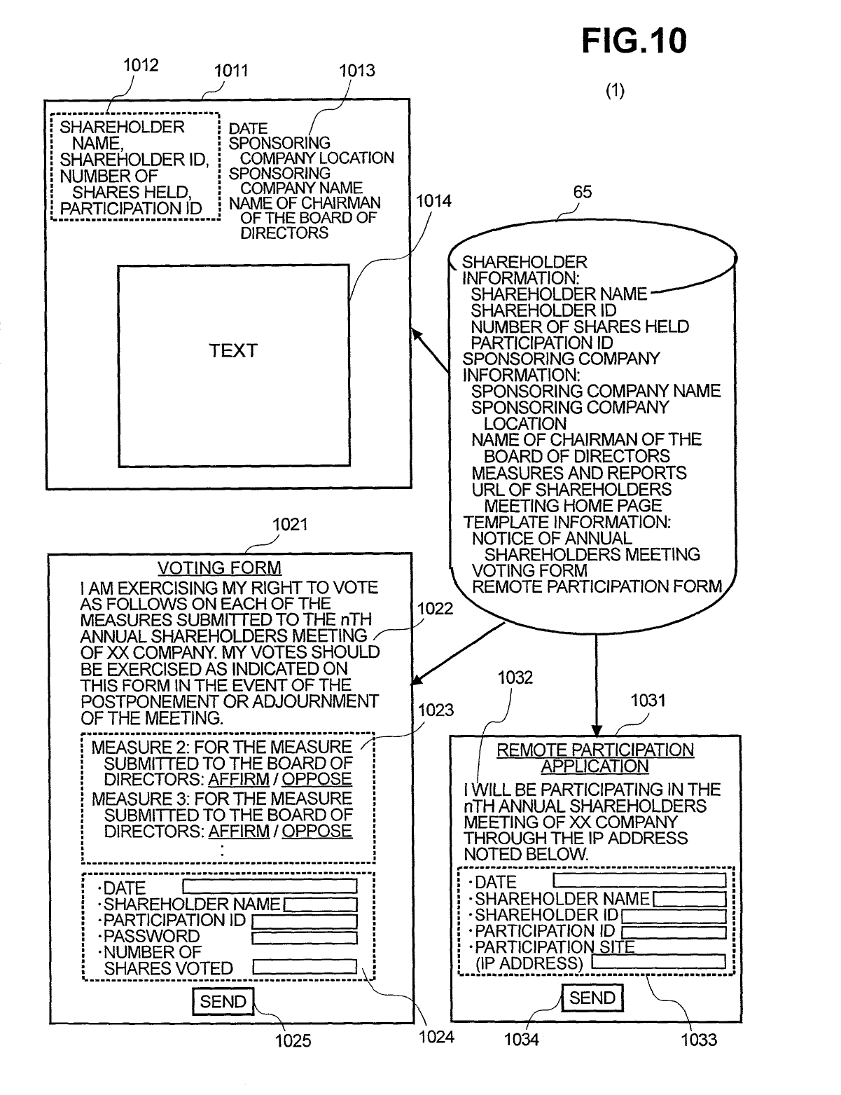

As shown in FIG. 10, the notices and so forth are generated by applying shareholder information or sponsoring company information to template information stored in the memory 65. The “notice of annual shareholders meeting”, “voting form”, “remote participation notice” are provided in the template information. In the present embodiment, however, the participation ID, generated with the participation ID generating process 223, is shown in the shareholder information region 1012 in only the “notice of annual shareholders meeting” 1011 and generated for each of the individual shareholders. Resolutions and reports, and the URL for the shareholders meeting home page of the sponsoring company are displayed in the text area 1014.

A typical text 1022 including the sponsoring company named is displayed in the “voting form” template 1021. Resolutions are read from the memory 65 and displayed along with the assent and opposition selections in the assent or opposition indicating area 1023. The voting shareholder information area 1024 is the area wherein the shareholder creating the voting form inputs his or her information. This date is the date written, the shareholder name is one's own name, and the participation ID is the area for entering the participation ID noted on the “notice of annual shareholders meeting” received by the shareholder. The number of shares to be voted is the area for entering the number corresponding to the number of shares owned, noted on the “notice of annual shareholders meeting”.

Although an explanation is omitted, a proxy template is prepared as a document having a similar function for large companies and may be handled in the same way as the voting form template. In that case, a field for entering the name of the proxy holder is further provided. The proxy will use the shareholder's participation ID and participate on the date of the meeting.

A typical text 1032 including the sponsoring company name is displayed on the “remote participation notice”. The shareholder information display area 1033 is the area to which a shareholder, communicating his or her remote participation to the sponsoring company before the electronic shareholders meeting, inputs his or her information. For example, this date is the date written, the shareholder name is one's own name, and the participation ID and shareholder ID are areas for entering the participation ID and shareholder ID noted on the “notice of annual shareholders meeting” received by the shareholder. When the shareholder has an electronic signature, a field for inputting the electronic signature may also be provided.

The participation location (IP address) is the area for entering the IP address indicating the shareholder's address as location where the shareholder participates in the electronic shareholders meeting. With this information, the sponsoring company can determine whether to allow participation by a shareholder in the electronic shareholders meeting depending on the shareholder's access point at the time of the meeting, by comparing the participation location at the time of the meeting against the participation location that was submitted in the remote participation notice.

Returning to FIG. 2, the transfer process 225, for transferring the contents generated by the process for generating the notices and so forth 224 to the remote shareholders sites 16n, is performed. Although not shown, the memory 65 is referenced and the notices and so forth are sent to the e-mail addresses corresponding to the shareholders in the notices.

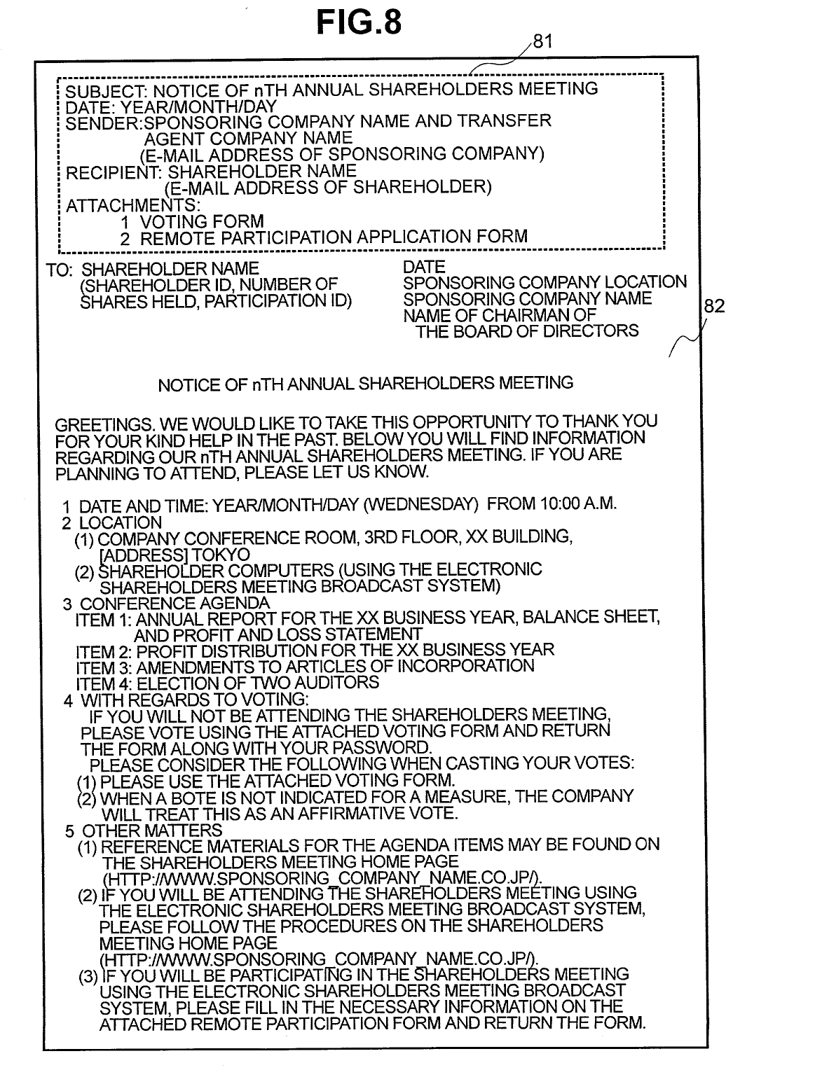

FIG. 8 shows an example of the notice. FIG. 8 shows a “notice of annual shareholders meeting” received and displayed on the terminal screen of a shareholder. The area 81 is the e-mail header. The subject, the date the e-mail was received, sender information (transfer agent company name and e-mail address), and recipient information (shareholder name and e-mail address) are displayed as the bibliographic information. The area 82 is the text display region and the “notice of annual shareholders meeting” template 1011 from FIG. 10 is displayed here. In the example in FIG. 8, the “voting form” and “remote participation form” are sent as attachments, as shown in the lower section of the region 81. In FIG. 8, reference materials for the meeting objectives are available on the shareholders meeting home page of the sponsoring company, but these may also be sent as attachments or by regular postal mail upon request from the shareholder.

When the notice in FIG. 8 is sent by e-mail from the transfer agent company site 12 to a remote shareholder site 16n, the remote shareholder references that notice. When the remote shareholder decides upon remote participation, the shareholder fills necessary items in the remote participation form attached to the notice 261 and executes the return process (262 in FIG. 2). The remote participation application 264 on which necessary items are noted is sent via e-mail to the sponsoring company and the process for tabulating the remote participants is received (113). A remote shareholder who is not participating in the shareholders meeting fills necessary items in the voting form attached to the notice 261 and executes the return process (263 in FIG. 2). The voting form 265 with the necessary items entered is sent to the sponsoring company and the process for tabulating the vote is performed 113.

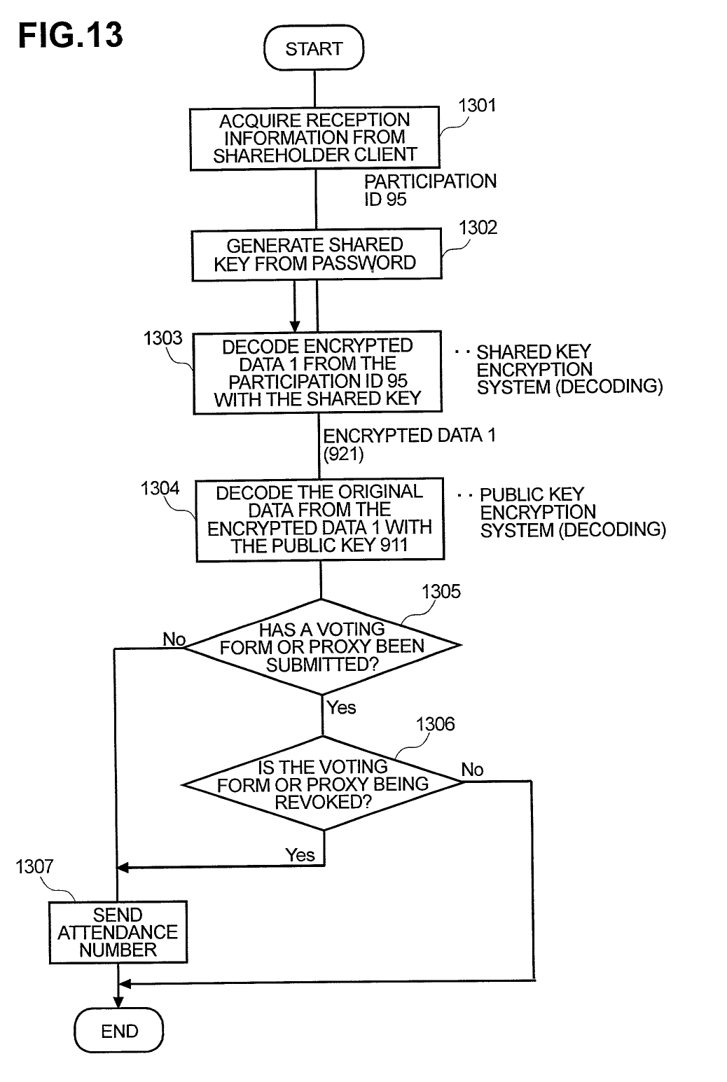

In the vote tabulation process 113, the recording of the voting forms and proxies received is checked for the electronic shareholders meeting concerned. Specifically, the matching, or checking of votes for each ID, is performed for the submitted shareholder ID of a shareholder. When a shareholder exercises his or her right to vote by submitting a voting form, the submitted content of newly received voting forms with tabulated voting rights or proxies removed is applied to tabulation, the old proxy removed, and a new proxy registered. This corresponds to the case of changing the proxy in the case where the content of the vote is changed as a result of examining reports or resolutions again after a shareholder has submitted a voting form. There is no reason to prevent a shareholder from changing his or her selection before the deadline to submit the voting form or proxy. Oppositely, the will of the shareholder can be correctly reflected in resolutions in the shareholders meeting through a checking mechanism like shareholder ID matching. Moreover, the process to decode the participation ID in order to attain the shareholder ID may use the same type of method as the process explained later with FIG. 13. The results from tabulating these votes are totaled with those exercised by shareholders attending on the date of the meeting (end of the arrow D).

In FIG. 2, the image scrambling key 112 is the key for scrambling images of the shareholders meeting later provided by the sponsoring company to the shareholders and this is sent to the satellite sites (end of arrow A). Also, information noted in the notice 261 and provided to remote shareholders is used for verification at the time of entering the electronic shareholders meeting (B).

The processing on the date of the meeting is explained next.

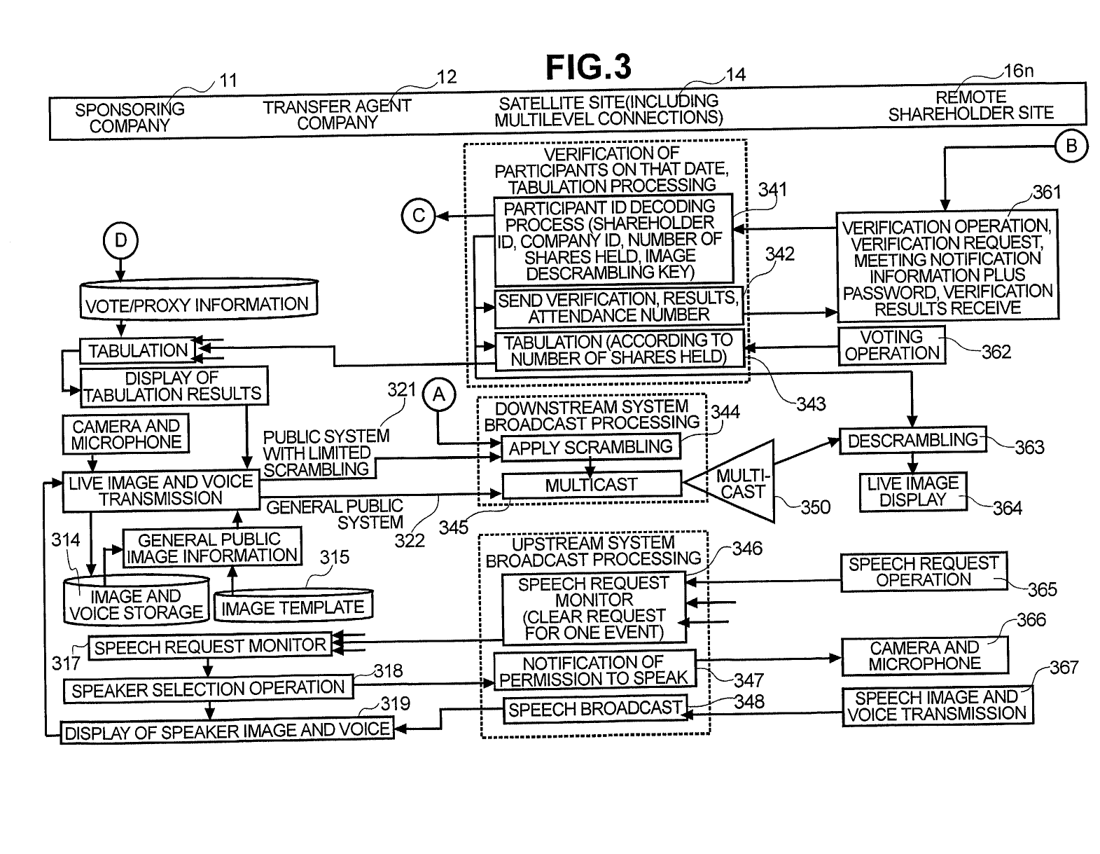

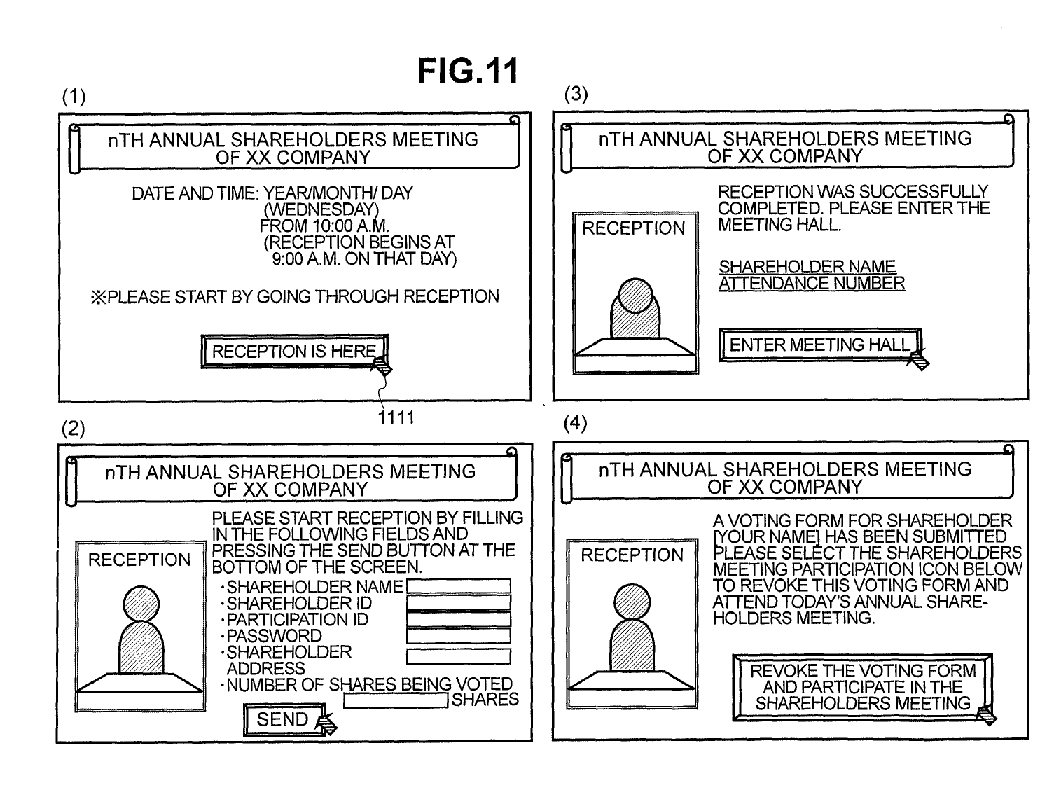

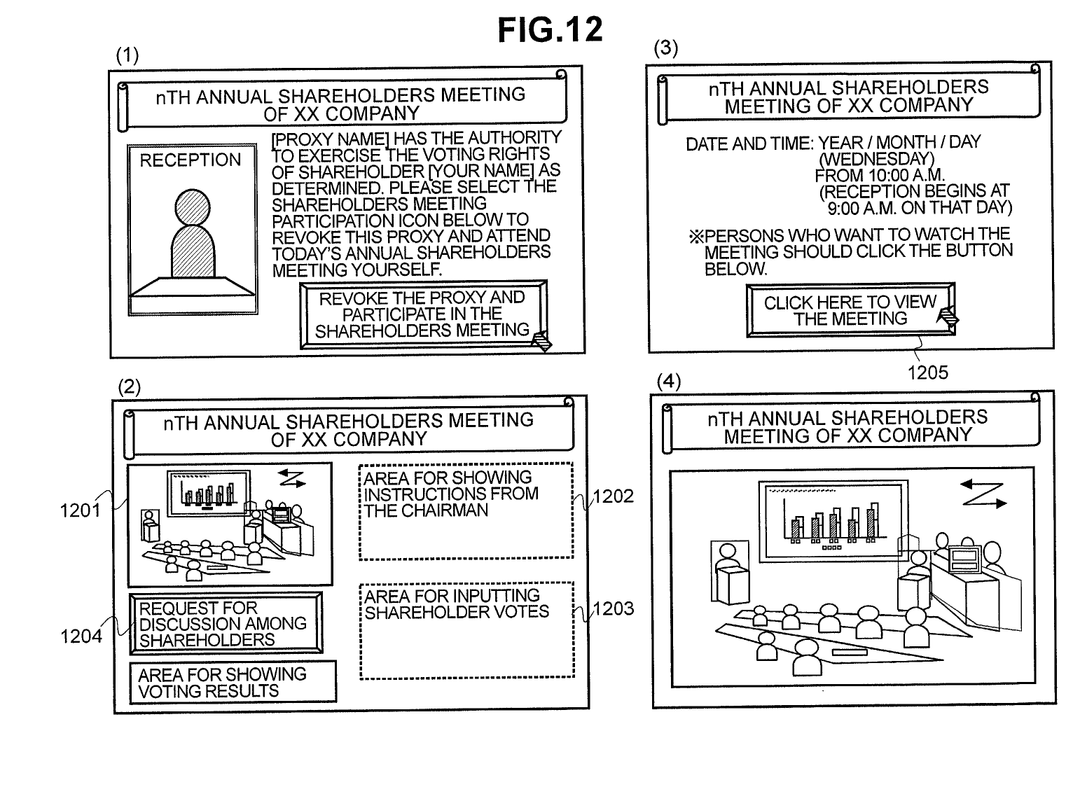

FIG. 3 shows processing relating to the verification process 361 for shareholders meeting clients 16n, vote processing 362, shareholders meeting image broadcast processing 364, and speech request response processing 365. Each of the processes is explained with examples from the screens (FIGS. 11 and 12) displayed on the shareholder clients 16n.

The shareholder verification process 361 is explained. The shareholders meeting client acquires the viewing browser software and special plug in software before the date of the shareholders meeting. FIG. 11 (1) shows the screen displayed upon arriving at the gateway to the periodic shareholders meeting from the shareholders meeting home page of the sponsoring company under that environment. Shareholders who are participating in the shareholders meeting go through reception and receive verification that they are legitimate shareholders.

The reception screen (FIG. 11 (2)) prompts the shareholder to input and send information necessary for reception. The information to be input here includes the contents noted in the notice of the shareholders meeting already received by the shareholder (B in FIG. 2) and the shareholder's own password.

In FIG. 11 (2), the shareholder name, shareholder ID, participation ID, number of shares to be voted, the shareholder's own password, and the shareholder's address are input. Sometimes the electronic signature may be input. The shareholder selects the send button with the cursor 1111 and sends this information to the satellite site.

At the satellite site, it is verified whether the shareholder going through reception is a legitimate shareholder using the participation ID and password received, and the public key of the sponsoring company (911 in FIG. 9). Here, the encrypted participation ID being decoded becomes the proof of a legitimate shareholder. The satellite server sends the number of shares read from the participation ID (included in the initial data decoded in FIG. 13, C in FIGS. 2 and 3) and the shareholder ID to the sponsoring company server.

In the vote tabulation process 113 from FIG. 2, the sponsoring company server checks whether the same shareholder has already (arrived prior to the day before the shareholders meeting) submitted a voting form or proxy, and upon confirming that duplicated votes have not been cast, notifies the shareholder client 16n through the satellite server that the verification of the shareholder client has been completed successfully (check 342). The shareholder ID, as well as the electronic signature, may also be used in the confirmation of duplicated votes.

In the case where a voting form has already been submitted by a shareholder client requesting reception, the shareholder client displays FIG. 11 (4) and inquires whether the shareholder would like to revoke the submitted voting form and participate in the shareholders meeting. If participating, the shareholder's vote is removed from the votes already tabulated by the sponsoring company. Likewise, in the case where a proxy has already been submitted, the screen in FIG. 12 (1) is displayed and the shareholder is asked whether the submitted proxy should be revoked. If the proxy is to be revoked, the registration of the proxy and votes is removed from the sponsoring company server.

Once confirmation of duplicated votes is complete and the shareholder is recognized as a legitimate shareholder, reception for the shareholders meeting ends and an attendance number is sent (FIG. 11 (3)). Also, when the participation ID is decoded, the image descrambling key is decoded as well and sent to the shareholder client. This is to allow the legitimate shareholder to participate in the electronic shareholders meeting while viewing images. Next, the shareholder client goes to the meeting hall from FIG. 11 (3) (selects the meeting entry icon), and then uses the image descrambling key received from the satellite site (363) to view the meeting images (364).

For the meeting images, the meeting hall live area 1201, chairman's instructions area 1202, and shareholder assent/opposition input area 1203, at a minimum, are displayed as shown in FIG. 12 (2). The meeting hall live area 1201 is the area showing images taken by a camera 312 established in the meeting hall. The meeting hall live images are scrambled by the satellite site with the image scrambling key (112, A in FIG. 2) passed from the sponsoring company to the satellite site in advance (344), multicast to the shareholder clients (or general viewers, discussed below) (350), and then made viewable by the shareholder clients 16n, which received those images, using the image descrambling key 363.

The chairman's instructions area 1202 is the area displaying questions from the chairman to shareholders and directives in text. During a live broadcast, voice is also output, but by displaying the chairman's directives in text, the same opportunities for speech are provided to remote shareholders as to those in the meeting hall that day. The shareholder clients can be clearly informed of periods when the chairman is allowing speech.

The shareholder assent/opposition input area 1203 is established to allow shareholders to approve/disapprove new measures and (motions, etc.). The button 1204 for requesting discussion among shareholders is established to allow shareholders participating in the meeting to talk among themselves. Dialogue among remote participation shareholders and among remote participation shareholders and shareholders in the meeting hall can be requested regardless of the current agenda.

With the explanation for FIG. 12 (2), it is also explained how the meeting images of the periodic shareholders meeting can also be viewed by general viewers, as well as shareholders attending meeting. FIG. 12 (3) shows the meeting gateway screen for general viewers. Through their home page, the company holding the meeting can allow general investors to watch as part of their IR (investor relations) activities. The people select the button 1205 using the cursor. Although not explained, the meeting images are sent to the viewers (FIG. 12 (4)) through the satellite site from the sponsoring company to persons who want to watch.

Image scrambling is not applied to meeting images for general viewers (FIG. 12 (4)). Naturally the viewers can only watch the meeting images and cannot speak at the meeting or vote. Also, the sponsoring company can compile and multicast meeting images for general viewers. In that case, images and voice (312 in FIG. 3) are captured with cameras and microphones in the meeting hall, pass through the live image/voices transmission process (313 in FIG. 3), and are stored temporarily in the image/voice storage means 314. Necessary cuts (scenes of the shareholders meeting) are taken from the stored images and voice the 314, undergo the general publication image generating process (316 in FIG. 3) into a separately prepared image template (315 in FIG. 3), and are multicast (345 in FIG. 3) by the satellite sites 14.

The template has a news report format; greetings from the removed sessions and meeting reports are used as the shareholders meeting report in the company introduction interval to complete the shareholders meeting program for general viewers. Moreover, the selection of cuts to be inserted in the template may also be automated by combining the scheduled times of the proceedings with camera work at that time and the actual image recognition process. Cut portions may also be selected manually while viewing the proceedings progress or stored images at the same time as the actual meeting.

The decoding process for the participation ID input in FIG. 11 (2) is explained with FIG. 13. This process is performed in 341 and 342 in FIG. 3 during the participation verification and tabulation processing on the pertinent date by the satellite site and 310 on the sponsoring company server 11. In Step 1301, the reception information is acquired from the remote shareholder terminal. The shared key is generated from the password (1302) and encrypted data 1 is decoded from the participation ID by the shared key encryption system (decoding) using that shared key. The decoded encrypted data 1 is the same as the encrypted data 921 generated in Step 92 in FIG. 9.

Next, the encrypted data (921) is decoded into the original data with the public key encryption system (decoding) using the public key 911 of the sponsoring company. The legitimacy of the shareholder client is proven by the decoding into the original data.

Next, this shareholder client confirms whether a voting form or proxy has been submitted in the past (1305). The satellite site sends the decoded shareholder ID to the sponsoring company server 11. The sponsoring company server 11 checks the information stored in the memory for votes exercised with the shareholder ID received from the satellite site. If no votes have been stored, the sponsoring company server takes the attendance number and sends it to the shareholder client through the satellite site 14. If votes have been cast, but the shareholder client indicates a desire to revoke the previous voting form, the sponsoring company server sends the attendance number to the shareholder client. The attendance number is not provided when the shareholder does not revoke previously submitted voting forms and proxies. When an electronic signature is used, a value, comprising the electronic signature turned into a string of digits by a hash function or the like, may be used instead of a password.

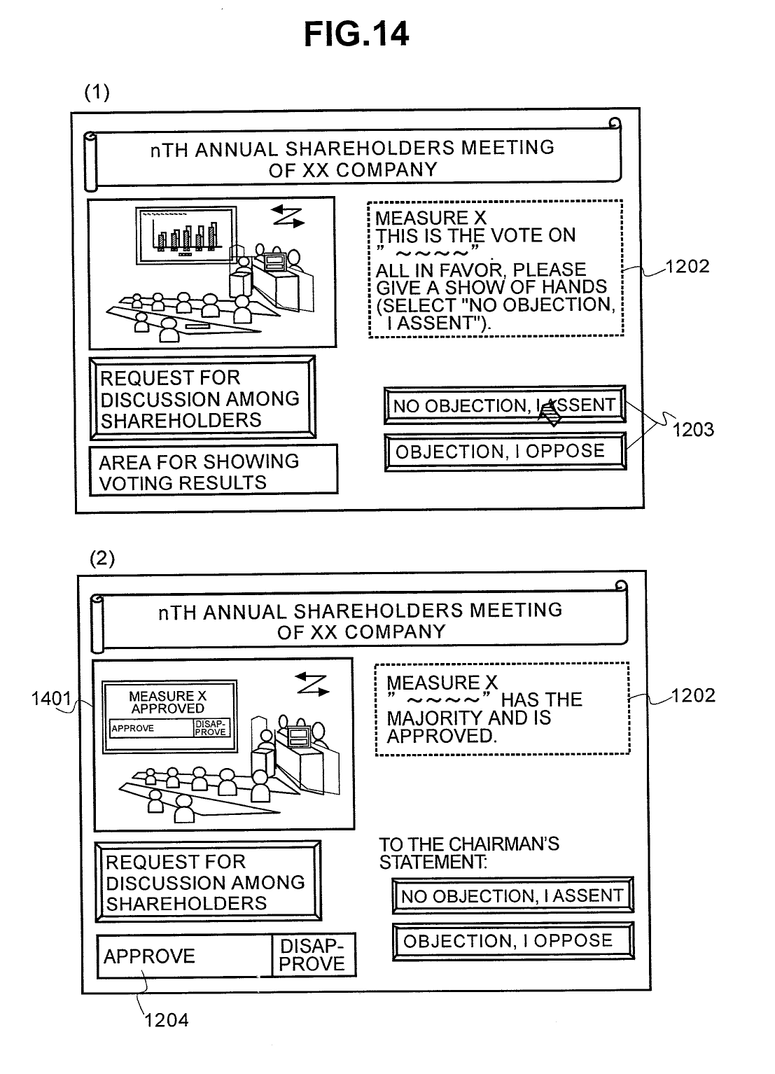

The voting operation (362 in FIG. 3) on the shareholders meeting clients 16n is explained next using the voting operation screens shown in FIG. 14. FIG. 14 (1) shows the scene where the chairman calls for a vote. The chairman's instructions are shown as text in the chairman's instructions display area 1202. Receiving these instructions, the shareholder indicates his or her choice with the cursor in the shareholder assent/opposition input area 1203. In FIG. 14 (1), the cursor indicates “no objection, I assent”. Upon receiving this, the satellite site 14 tabulates (first order tabulation results) the number of shares belonging to shareholders who selected “no objection, I assent” on all the shareholder clients 16n connected to that satellite site 14.

The satellite site 14 sends those tabulation results to the sponsoring company serving 11. The sponsoring company server 11 performs a second order tabulation on the first order tabulation results sent from the satellite sites 14, attains a final count of affirmative votes, and displays the final tabulation results on the output screen 1401 provided to the meeting hall (311 in FIG. 3). Along with live image and voice transmission (313 in FIG. 3), the final tabulation results are also displayed in the voting results display area (1204 in FIG. 14 (2)) on the display screens of the shareholder clients 16n. In this way, the voting preferences of all of the shareholders, those attending the meeting, those not attending the meeting who sent proxy votes, and those attending the meeting remotely, are counted in an efficient manner.

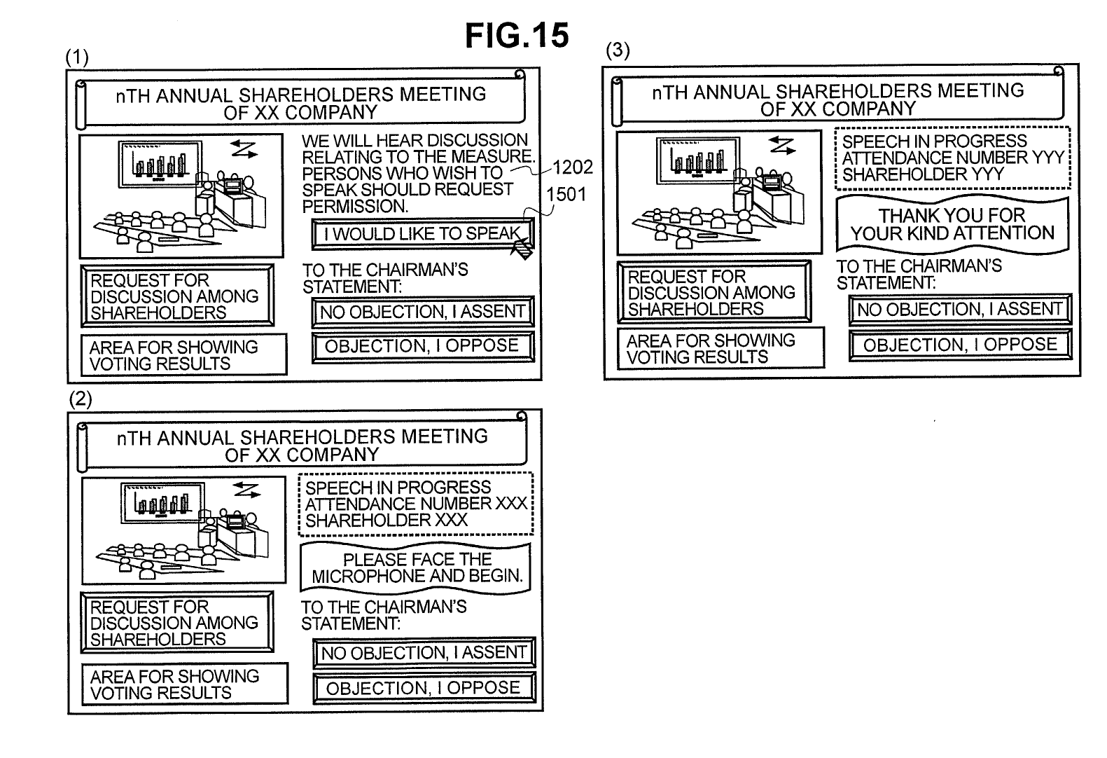

The speech request operations (365, 366, and 367 in FIG. 3) of the shareholders meeting clients 16n are explained next. The speech request operations are operations created for asking questions or stating opinions regarding measures. FIG. 15 shows the display screens for the shareholders clients 16n when the chairman allows shareholders to talk and the shareholders are talking. When the chairman permits shareholders to talk and ask questions and so forth, a message to that effect is displayed in the chairman's instructions display area 1202 in FIG. 15 (1). When a client viewing this screen wishes to talk, the client selects the “I would like to speak” button (1501) with the cursor. Thereupon, that request to speak is sent through the speech request monitor (346 in FIG. 3) of the satellite site 14 to the speech request monitor (317 in FIG. 3) of the sponsoring company server 11.

The speech request monitor 317 carries out a speaker selection operation (318 in FIG. 3). Because only one shareholder is allowed to speak at a time, the screen in FIG. 15 (3) is multicast (350 in FIG. 3) while notification of permission to speak is sent to the selected shareholder (347 in FIG. 3) and the screen in FIG. 15 (2) is sent to that shareholder specifically. This shareholder who is permitted to speak employs images and voice from a camera and microphone and sends his or her images and speech through the satellite site 14 to the sponsoring company server 11. Along with outputting the speaker's voice and image at the meeting hall (319 in FIG. 3), the sponsoring company server 11 multicasts the image and voice to remote shareholders with a live image/voice transmission process (313 in FIG. 3). Moreover, in FIG. 15, the example shows where the speaker's voice is used and that voice is heard by other shareholder clients, but it is also possible to multicast images comprising the speaker's image display area.

Questions may be submitted by the shareholders to the chairman in a similar manner. A period of time is provided by the chairman during which shareholders may ask a question. For shareholders physically located at the meeting hall, they simply raise their hands. For remote shareholders, they “raise” their hands by pressing the “I would like to speak” button (1501), indicating their request to ask a question. Typically, the chairman will select one shareholder during that period of time, and will answer his/her question. The requests for questions by the other shareholders, those physically present and the remote shareholders, are ignored and not answered. After the answer is provided, the process is repeated where another period of time is provided during which shareholders “raise” their hands to ask a question.

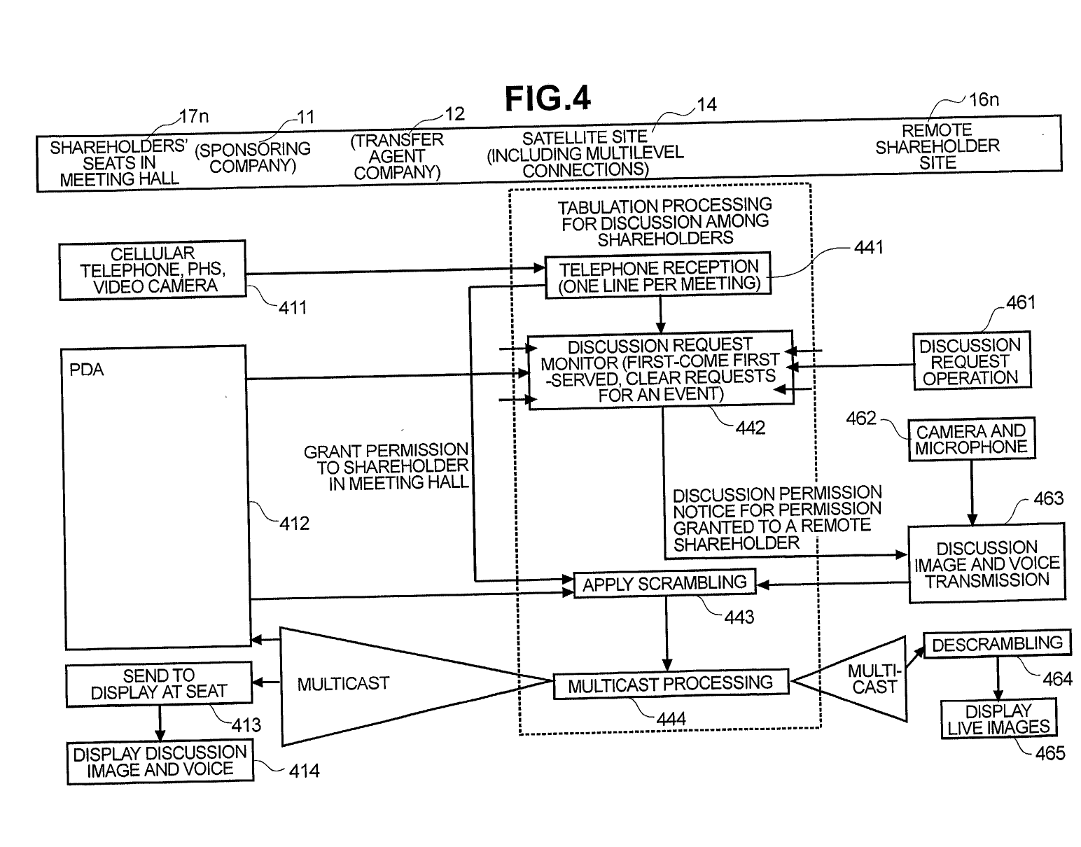

The processing for the discussion request operation 461 in FIG. 4 is begun when the shareholder client 16n of a remote shareholder site selects the “request discussion among shareholders” button 1204 in FIG. 12. The presence of a discussion request from the meeting hall shareholder terminals (including PDA 412) when the “request discussion among shareholders” button 1204 is pressed by a shareholder client 16n is monitored by the discussion request monitor 442 on the satellite site 14. Also, the discussion request monitor monitors requests for discussion among shareholders made by shareholders present in the meeting hall through their cellular telephones or PHS personal handyphones (411) through telephone reception 441.

From among these discussion requests, the discussion request monitor 442 gives permission to the discussion request made first. The shareholder client who received permission employs images and voice by camera and microphone (462) from his or her own terminal and sends these as the discussion images and voice to the satellite site 14 (464). The discussion images and voice sent undergo appropriate scrambling processing in the satellite site (443) and are multicast to other remote shareholder clients and terminals of shareholders in the meeting hall (444). The multicast images and voice are descrambled (464) and the live images are displayed (465). Also, although not shown, the images and voice are descrambled at the seats of shareholders at the meeting hall and sent to the individual displays (413), and the discussion image and voice are displayed at each terminal (414).

The requests for discussion among shareholders are cleared for each incident in the discussion request monitor 442. In effect, when discussion permission is given to one shareholder from among discussion requests from a plurality of shareholder clients, the discussion requests of other shareholders are cleared and the discussion request monitor is started again. Shareholders wanting to hold discussions privately with the shareholder who received discussion permission submit discussion requests and are selected in the order in which their requests were received. At that time, the shareholder forms a discussion pair with the first selected shareholder and can hold discussion directly through bi-directional communications. When a pair is established, the discussion request monitor 442 checks for the next discussion request and establishes the next discussion pair if there is a request. The number of discussion pairs may be established at the discretion of the sponsoring company. Moreover, so that shareholder discussions cannot be heard by the managers, the discussion is output to the earphones and displays provided at the shareholders'seats in the meeting hall.

This explanation concerned conducting the electronic shareholders meeting with the sponsoring company server 11 and transfer agent company server 12, but the processing to be performed by either server depends on the scope of the procedures that the sponsoring company has the transfer agent company perform. Consequently, processing by the transfer agent company server 12 may also be performed by the sponsoring company server 11.

Also, the primary reason for having a plurality of satellite sites 14 is to distribute the processing for the remote shareholder clients 16n . Particularly in the case of tabulating the results input from shareholder clients, such as voting, the results can be attained in a shorter period of time and without keeping the shareholders at the meeting hall waiting.

At current shareholders meetings, shareholders sometimes referred to as dissident shareholders attempt to disrupt the proceedings of the meeting by preventing the chairman from making progress and try to take over the meeting. For an electronic shareholders meeting, however, the applicants of the disclosed invention have considered that this type of activity takes the form of frequent access to the servers and that interfering with the business at hand is replaced with interfering with processing for tabulation, voting, and question-and-answer sessions. As discussed above, the shareholder clients are divided among a plurality of satellite servers and even if a satellite server to which a dissident shareholder is connected is accessed frequently by such a shareholder, this will not interfere with the meeting because the voting rights of many other shareholders are administered on other satellite servers and the administration of submitted votes and proxies is performed on the sponsoring company server.

In the event of interference with tabulation during voting by dissident shareholders, the total number of votes for shareholder clients connected to the satellite site under attack is known and therefore, comparing this to the total number of votes of the shareholders of other satellite sites and the total number of submitted votes and proxies it is possible to determine the passage of a vote even if the votes from the compromised satellite site are improperly counted.

As discussed above, the present invention makes it possible for shareholders who are living in remote locations to participate in a general shareholders meeting. The remote shareholders can discuss shareholder opinions just like shareholders attending the meeting and can exercise their rights to vote in real time. Without having to set up high-performance servers for an annual shareholders meeting, the sponsoring company distributes the processing for conducting a shareholders meeting among already existing satellite sites and performs hierarchical processing, and can therefore receive votes from remote shareholders in real time.

What is claimed is:

1. In a first server, a method for conducting a shareholders meeting with remote participation comprising:
notifying a plurality of shareholders of a shareholders meeting;
receiving notification from at least some of said shareholders indicating that they will attend said shareholders meeting as remotely attending shareholders, each remotely attending shareholder having an associated second server, said second servers providing shareholders meeting services to said remotely attending shareholders;
transmitting meeting proceedings to said second servers for subsequent transmission to said remotely attending shareholders; and
producing a final tabulation of votes indicating the voting preferences of all of said shareholders on issues brought up during said shareholders meeting,
said producing including for each of said second servers:
receiving a voting form from each of its associated remotely attending shareholders;
tabulating said voting form to produce a tabulated votes result; and
transmitting said tabulated votes result to said first server, said final tabulation of votes including tabulated votes results from all of said second servers.

2. The method of claim 1 wherein at each of said second servers if one of its associated remotely attending shareholders had cast an earlier voting form, then ignoring said earlier voting form in favor of a most recent voting form.

3. The method of claim 1 further including receiving for a period of time a plurality of requests to ask a question, selecting one of said requests to ask a question during said period of time, providing an answer to said question, and ignoring those of said requests to ask a question which have not been selected, said plurality of requests to ask a question including requests from said second servers which have been submitted by said remotely attending shareholders.

4. The method of claim 1 further including transmitting participant information to each of said remotely attending shareholders, said participant information including an encrypted portion and an unencrypted portion, wherein said participant information is transmitted by said remotely participating shareholders to said second servers, said second servers decrypting said encrypted portion to produce a decrypted output and comparing said decrypted output with said unencrypted portion to verify said remotely attending shareholders for participation in said shareholders meeting.

5. The method of claim 4 wherein said unencrypted portion comprises shareholder information and said encrypted portion includes said shareholder information in encrypted form.

6. The method of claim 4 wherein said encrypted portion includes a descrambling key, said meeting proceedings being in encrypted form, the method further including transmitting said descrambling key from said second servers to said remotely participating shareholders who use it to decrypt said meeting proceedings.

7. The method of claim 1 wherein said step of notifying includes transmitting to a third server an information signal indicative of said shareholders meeting, and in response to said information signal producing at said third server a shareholders meeting notification and transmitting it to said shareholders.

8. The method of claim 1 further including providing for discussion only among said shareholders, including receiving at one of said second servers audio-visual information from one of its associated remotely attending shareholders and transmitting said audio-visual information only to all of said shareholders.

9. A method for conducting a shareholders meeting comprising:
notifying shareholders of a shareholders meeting, said shareholders meeting taking place at a first location;
identifying a plurality of remote shareholders who will attend said shareholders meeting remotely, each remote shareholder having an associated satellite server site which provides shareholders meeting services, said satellite server sites in communication via a data communication network with a shareholders meeting server system located at said first location;
producing first audio-visual information at said first location; and
transmitting said first audio-visual information to each of said satellite server sites so that said remote shareholders can view proceedings of said shareholders meeting,
each of said satellite server sites:
receiving voting forms from its associated remote shareholders, including deleting an earlier received voting form of a remote shareholder who submits a subsequent voting form;
tabulating said voting forms to produce a tabulated result; and
sending said tabulated result to said shareholders meeting server system,
said shareholders meeting server system, tabulating votes of said shareholders including tabulating tabulated results received from said satellite server sites.

10. The method of claim 9 further including receiving for a period of time a plurality of requests to ask a question, selecting one of said requests to ask a question during said period of time, providing an answer to said question, and ignoring those of said requests to ask a question which have not been selected, said plurality of requests to ask a question including requests from said satellite server sites which have been submitted by said remote shareholders.

11. The method of claim 9 further including transmitting participant information to said remote shareholders, said participant information comprising encrypted shareholder information and unencrypted shareholder information, wherein said remote shareholders transmit said participant information to their associated satellite server sites, and in response to receiving said participant information said satellite server sites decrypting said encrypted shareholder information to produce an output and comparing said output against said unencrypted shareholder information to verify said remote shareholders for participation in said shareholders meeting.

12. The method of claim 11 wherein said participant information further includes an encrypted descrambling key, said first-audio visual information being in encrypted form, the method further including transmitting said descrambling key from said satellite servers sites to said remote shareholders who use it to decrypt said first-audio visual information.

13. The method of claim 9 further including receiving at one of said satellite server sites second audio-visual information from one of its assigned remote shareholders and transmitting said second audio-visual information to said shareholders meeting server system, said shareholders meeting server system transmitting said second audio-visual information to all of said satellite server sites so that said remote shareholders can actively participate in said shareholders meeting.

14. The method of claim 9 further providing for discussion only among said shareholders, including receiving at one of said satellite server sites second audio-visual information from one of its assigned remote shareholders and transmitting said second audio-visual information only to all of said shareholders.

15. The method of claim 9 wherein said step of notifying shareholders includes transmitting a signal to an agent server and in response to said signal, said agent server preparing a shareholders meeting notice and sending it to said shareholders.

16. A method for conducting a shareholders meeting comprising:
notifying shareholders of a shareholders meeting, said shareholders meeting taking place at a first location;
identifying a plurality of remote shareholders who will attend said shareholders meeting remotely, each remote shareholder having an associated satellite server site which provides shareholders meeting services, said satellite server sites in communication via a data communication network with a shareholders meeting server system located at said first location;
producing first audio-visual information at said first location;
transmitting said first audio-visual information to each of said satellite server sites so that said remote shareholders can view proceedings of said shareholders meeting;
receiving for a period of time a plurality of requests to ask a question, including requests from said satellite server sites which have been submitted by said remote shareholders;
selecting one of said requests to ask a question during said period of time; and
providing an answer to said question, wherein those of said requests to ask a question which have not been selected are ignored.

17. The method of claim 16 further including at each of said satellite server sites:
receiving voting forms from its associated remote shareholders;
tabulating said voting forms to produce a tabulated result; and
sending said tabulated result to said shareholders meeting server system,
said shareholders meeting server system, tabulating votes of said shareholders including tabulating tabulated results received from said satellite server sites to produce a final tabulation of votes on issues presented during said shareholders meeting.

18. The method of claim 17 further including deleting an earlier received voting form of a remote shareholder who submits a subsequent voting form.

19. The method of claim 16 further including transmitting participant information to said remote shareholders, said participant information comprising encrypted shareholder information and unencrypted shareholder information, wherein said remote shareholders then transmit said participant information to their associated satellite server sites, in response to receiving said participant information said satellite server sites decrypting said encrypted shareholder information to produce an output and comparing said output against said unencrypted shareholder information to verify said remote shareholders for participation in said shareholders meeting.

20. The method of claim 19 wherein said encrypted shareholder information includes a descrambling key, said first-audio visual information being in encrypted form, the method further including transmitting said descrambling key from said satellite server sites to said remote shareholders who use it to decrypt said first-audio visual information.

21. A server system for conducting a shareholders meeting with remote shareholders comprising:
a computer component having a memory store,
said memory store having first program code configured to operate said computing unit to notify a plurality of shareholders of a shareholders meeting,
said memory store further having second program code configured to operate said computing unit to receive notification from at least some of said shareholders indicating that they will attend said shareholders meeting as remote shareholders, each remotely attending shareholder having an associated second server which provides shareholders meeting services,
said memory store further having third program code configured to transmit meeting proceedings to said second servers for subsequent transmission to said remotely attending shareholders,
said memory store further having fourth program code configured to produce a final tabulation of votes indicating the voting preferences of all of said shareholders on issues brought up during said shareholders meeting, including code configured to operate said computing unit to receive a tabulated votes result from each of said second servers,
said second servers including fifth program code configured to:
receive a voting form from each of its associated remotely attending shareholders;
tabulate said voting form to produce said tabulated votes result; and
transmit said tabulated votes result to said first server,
wherein said final tabulation of votes includes tabulated votes results from all of said second servers.

22. The system of claim 21 wherein each of said second servers includes sixth program code configured to operate said computing unit to delete an earlier voting form of a remote shareholder who has submitted a subsequent voting form.

23. The system of claim 21 wherein said memory includes sixth program code configured to operate said computing unit to receive questions from said second servers which have been submitted by said remotely attending shareholders and to answer some of said questions for a period of time, said sixth program code further configured to operate said computing unit to delete those of said questions which have not been answered when said period of time has elapsed.

24. The system of claim 21 wherein said memory further includes sixth program code configured to transmit participant information to each of said remotely attending shareholders, said participant information including an encrypted portion and an unencrypted portion, wherein said participant information is transmitted by said remotely participating shareholders to said second servers, said second servers including seventh program code configured to decrypt said encrypted portion thus producing a decrypted output and to compare said decrypted output with said unencrypted portion thus verifying said remotely attending shareholders for participation in said shareholders meeting.

25. The system of claim 24 wherein said encrypted portion includes a descrambling key, said meeting proceedings being in encrypted form, wherein said descrambling key is transmitted from said second servers to said remotely attending shareholders who use it to decrypt said meeting proceedings.

26. A first server system for conducting a shareholders meeting with remote shareholders comprising:
means for notifying a plurality of shareholders of a shareholders meeting;
means for receiving notification from at least some of said shareholders indicating that they will attend said shareholders meeting as remotely attending shareholders, each remotely attending shareholder having an associated second server system, said second server systems providing shareholders meeting services to said remotely attending shareholders;
means for transmitting meeting proceedings to said second server systems for subsequent transmission to said remotely attending shareholders; and
means producing a final tabulation of votes indicating the voting preferences of all of said shareholders on issues brought up during said shareholders meeting,
said means for producing including for each of said second server systems:
means for receiving a voting form from each of its associated remotely attending shareholders;
means for tabulating said voting form to produce a tabulated votes result; and
means for transmitting said tabulated votes result to said first server system,
said final tabulation of votes including tabulated votes results from all of said second server systems.

27. The system of claim 26 wherein at each of said second server systems, if one of its associated remotely attending shareholders had cast an earlier voting form, then ignoring said earlier voting form in favor of a most recent voting form.

28. The system of claim 26 further including means for answering questions, said means configured to:
receive for a period of time a plurality of requests to ask a question, including requests from said second server systems which have been submitted by said remotely attending shareholders;
select one of said requests to ask a question during said period of time;
provide an answer to said question; and
ignore those of said requests to ask a question which have not been selected.

29. The system of claim 26 further including means for transmitting participant information to each of said remotely attending shareholders, said participant information including an encrypted portion and an unencrypted portion, wherein said participant information is transmitted by said remotely participating shareholders to said second servers, said second servers including means for decrypting said encrypted portion to produce a decrypted output and means for comparing said decrypted output with said unencrypted portion to verify said remotely attending shareholders for participation in said shareholders meeting.

30. The system of claim 29 wherein said encrypted portion includes a descrambling key, said meeting proceedings being in encrypted form, wherein said descrambling key is transmitted from said second servers to said remotely participating shareholders who use it to decrypt said meeting proceedings.

31. The system of claim 26 wherein said means for notifying includes means for transmitting to a third server an information signal indicative of said shareholders meeting, and in response to said information signal producing at said third server a shareholders meeting notification and transmitting it to said shareholders.

32. The system of claim 26 further including means for providing for discussion only among said shareholders, including means for receiving at one of said second servers audio-visual information from one of its associated remotely attending shareholders and means for transmitting said audio-visual information only to all of said shareholders.
